(19) United States
(12) Patent Application Publication
(10) Pub. No.: US 2024/0308167 A1
(43) Pub. Date: Sep. 19, 2024

(54) TWIN SCREW PRESS FOR PALM OILS AND SIMILAR

(71) Applicant: C.I. TEQUENDAMA S.A.S., Santa Marta (CO)

(72) Inventors: Robert BOYD JOHNSTON, Tampa, FL (US); Maria del Pilar NORIEGA ESCOBAR, Medellín (CO); Walter RITZEL FESKE, Santa Marta (CO)

(21) Appl. No.: 18/605,218

(22) Filed: Mar. 14, 2024

Related U.S. Application Data
(60) Provisional application No. 63/490,051, filed on Mar. 14, 2023.

(51) Int. Cl. B30B 9/16; B30B 9/12

(52) U.S. Cl. CPC B30B 9/16; B30B 9/121

(57) ABSTRACT

The present disclosure describes embodiments of a twin-screw press for extracting vegetable oils, and a process for extracting vegetable oils and/or seeds. Particularly, the twin-screw press provides a reduction in machine cost and maintenance due to low operating torque requirements and allows an improved operation with the oil extraction being greater than the oil loss. This is a consequence of allowing lower processing temperatures and pressures due to the geometry of the screw and the gap that it has with the draining element of the press cage. This also permits reducing the possibility of material jamming or co-rotation of the cake in the press.

### RELATED TECHNICAL FIELD

The present disclosure relates to oil extraction apparatuses and methods. In particular, it is related to screw presses for extracting vegetable oils, and more particularly to twin-screw presses.

### BACKGROUND

Document U.S. Pat. No. 6,550,376 discloses a screw press with twin-screws having discontinuities or interruptions in the flighting of the screws. Also, this document discloses stationary resistor teeth that protrude at these interruptions into the flow of material being pressed. The two parallel counter-rotational screw shafts are mounted horizontally within said frame, wherein said screw shafts are mounted side by side in parallel relation to the bottom of said frame, one of said screw shafts having left-hand flighting, the other of said screw shafts having right-hand flighting, said flighting overlapping each other. This document further mentions an outlet opening for the discharge of solids from said screw press at said downstream end of said frame, and a filtering element for filtering liquid from said material, wherein said filtering element surrounds a portion of a length of said screw shafts.

The document CN216635517 discloses a twin-screw palm oil press, comprising a box provided with an oil extraction cavity, which is symmetrically rotating connected with two screws. The screws are matched, and the box is provided with a cavity fixedly connected to a motor. The document also mentions that a lower side of the box is fixedly connected with a discharge pipe, and the discharge pipe is connected to the oil extraction cavity. The lower side of the discharge pipe is provided with a connection pipe, the upper side of the connection pipe is provided with a connection slot, and the discharge pipe is set through the connection slot. The document mentions that this palm oil press improves the temperature inside the oil extraction cavity and can better complete the oil extraction operation at the same time. Also, it mentions that it can complete the simple filtering operation of the discharged material and perform a simple operation.

### SUMMARY

The present disclosure describes embodiments of a twin-screw press for extracting vegetable oils. The twin-screw press includes a press cage having a feeding section located in a proximal zone of the press cage; a cake discharge section located in a distal zone of the press cage; and a medial section located between the feeding section and the cake discharge section. Also, the press cage has a draining element located in the medial section and is configured to retain a cake comprising vegetable solids and drain vegetable oil. The twin-screw press further includes a first screw and a second screw arranged inside the press cage. Each screw includes a shaft arranged inside the press cage, and a flighting arranged on the shaft. Also, each screw has a distal end and a proximal end mounted on bearing housings. Furthermore, the proximal end and/or the distal end of each screw may be configured to be connected to a power transmission unit, wherein the screws are intermeshed to it. The twin-screw press also may include a discharge-restricting device connected to the cake discharge section and configured to control a cake flow. The twin-screw press is configured to process vegetable fruits and seeds and extract liquids and oils from them. Examples of vegetable fruits and seeds are oil palm fruit, sunflower seeds, olive fruit, fruits of plants of the Elaeis guineensis, Elaeis guineensis x Elaeis oleifera, Elaeis genre, and any other suitable fruit or seed known by a skilled person, and combinations thereof.

Furthermore, the twin-screw press provides a reduction in machine cost and maintenance due to low operating torque requirements and allows an improved operation with the oil extraction being greater than the oil loss. This is a consequence of allowing lower processing temperatures and pressures due to the geometry of the screw and the gap that it has with the draining element of the press cage. This also permits reducing the possibility of material jamming or co-rotation of the cake in the press.

Additionally, the present disclosure describes embodiments of a process for extracting vegetable oils with a twin-screw press according to any of the herein-described embodiments. The process includes a step of feeding vegetable fruits in a feeding section of a press cage of the twin- screw press, and a step of obtaining a cake and an oil by processing the vegetable fruits along a medial section of the press cage, applying a shared compression force with a first screw and a second screw that are arranged inside the press cage. The process further includes a step of extracting the oil through a draining element of the press cage; and a step of extracting the cake through a cake discharge section located in a distal zone of the press cage, wherein the cake may include nuts and pulp of the vegetable fruits. The press can be operated at a wide range of temperatures, such as, but is not limited to, between ambient temperature to 59° C.; between ambient temperature to 60° C.; between ambient temperature to 100° C.; between 60° C. to 100° C. or a combination of temperatures that allow the press to soften and easily extract the oil.

In the context of the present disclosure, ambient temperature, or room temperature, should

refer to a temperature in the range of 0° C. to 30° C. However, it is worth noting that ambient temperature or room temperature may vary depending on the geographic and climatic conditions.

Any of the herein-described embodiments of the twin-screw press, and the process that employs them, allow reducing the power required, reduces the rate of palm nuts broken in the pressing phase, and, consequently, greatly reduces the presence of lauric acid in the production of palm oils. Also, the twin-screw press allows a reduction or even elimination of the use of fluid addition which fluid must subsequently be removed from the oil being produced, and a reduction of oil content in the press cake fiber (i.e., oil loss). Furthermore, the herein-described embodiments of the twin-screw press provide an advantage in the case of the palm oil extraction process, as the screws with shafts, provided in an intermeshed arrangement, allow the removal of fibers from the nut of the oil palm fruits by friction, and prevent that the nut, breaks. Hence, the twin-screw press benefits a Palm Kernel Oil (PKO) extraction process that takes as raw material the unbroken nuts of the oil palm fruits.

The process permits extracting vegetable oils from vegetable fruits and seeds. Examples of vegetable fruits and seeds are oil palm fruit, sunflower seeds, olive fruit, fruits of plants of the Elaeis guineensis, Elaeis guineensis x Elaeis Oleifera, Elaeis genre, any other suitable fruit or seed known by a skilled person, and combinations thereof.

### BRIEF DESCRIPTION OF THE FIGURES

FIG. 1 shows a side view of an embodiment of the herein-described twin-screw press (1), having a cut section that shows a screw and details of a press cage. This figure further includes a detailed top view of the twin-screws showing their flighting details.

FIG. 2 shows a top view of an embodiment of the herein-described twin-screw press, and a detail of the twin-screws. This figure further includes a detailed view of the screws.

FIG. 3 shows a detailed view of a medial section of a press cage of an embodiment of the herein-described twin-screw press. The press cage has resistor teeth (32) configured to fit gaps (24) in between flighting sections of each screw. This figure further includes a detailed view of the resistor teeth (32).

FIG. 4 shows the detailed view of the medial section of the press cage shown in FIG. 3, and detailed views of the draining element (15).

FIG. 5 shows the detailed view of the distal section of the press cage shown in FIG. 3, and detailed views of an embodiment of a discharge-restricting device (7) located in a cake discharge section of the press cage.

FIG. 6 shows a cross section of an embodiment of the twin screw press, including a detailed view of an adjustment element (9) located in the press cage.

FIG. 7 shows a top view of an embodiment of the twin-screw press with dual output shaft gearbox. This figure further includes a detailed view of the screws (2, 3).

### DESCRIPTION OF THE DISCLOSURE

The present disclosure describes embodiments of a twin-screw press (1) for extracting vegetable oils and liquids from vegetable fruits and/or seeds.

The term “vegetable oils” as used herein encompasses a diverse array of lipid-based substances derived from botanical sources. This includes, but is not limited to, oils extracted from any part of a plant, such as leaves, stems, roots, flowers, as well as fruits and seeds. Furthermore, the term “vegetable oil” should be interpreted to include not only the conventional cold-pressed and hot-pressed oils but also refined oils, unrefined oils, essential oils, absolutes, oleoresins, and phytosterols extracted using the twin-screw press (1). Additionally, the term extends to encompass bio-oils or bio-liquids derived from algal, fungal, or microbial sources, reflecting the breadth of vegetative sources. The extraction methods considered under this term may involve mechanical pressing, solvent extraction, supercritical fluid extraction, enzymatic methods, or any other technique that yields an oil or oil-like substance from vegetative material.

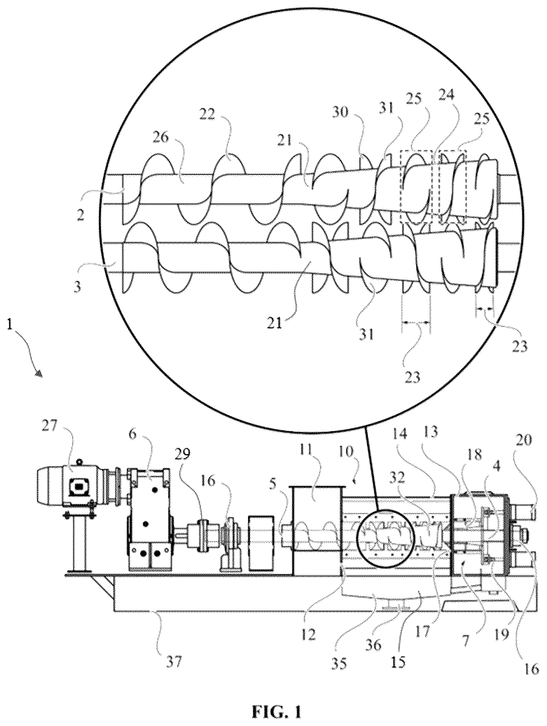

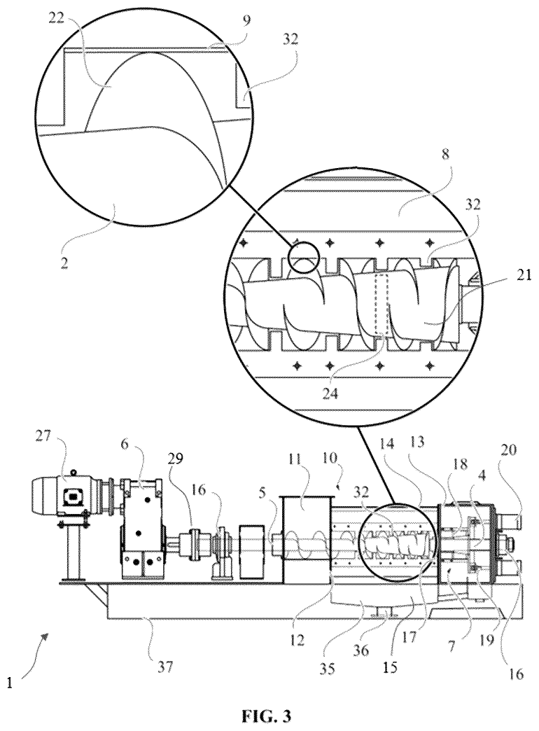

Referring to FIG. 1, and FIG. 3, the twin-screw press (1) includes a press cage (10) having a feeding section (11) located in a proximal zone (12) of the press cage (10); a cake discharge section (13) located in a distal zone of the press cage (10); and a medial section (14) located between the feeding section (11) and the cake discharge section (13).

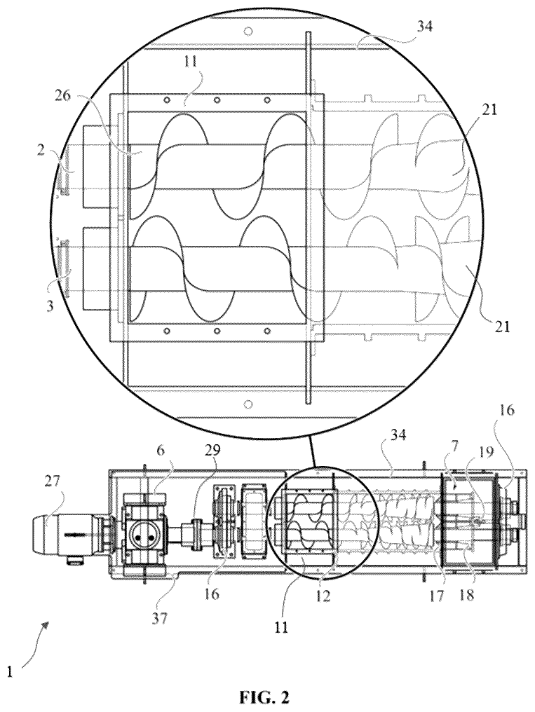

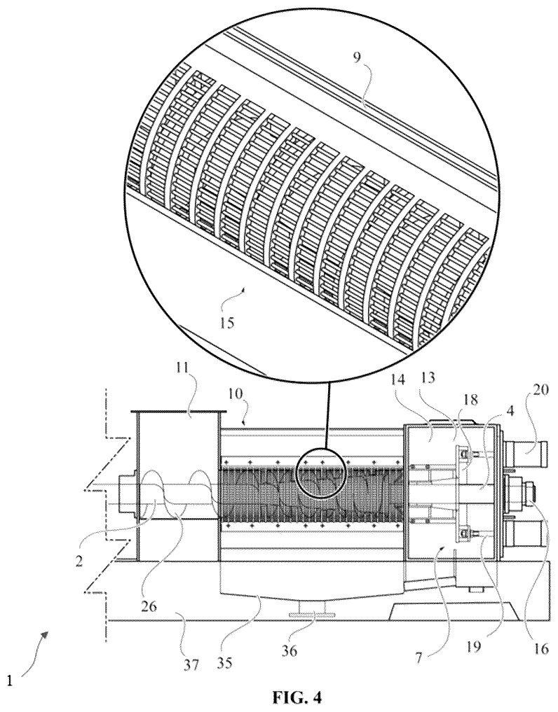

The press cage (10) may further comprise strainers and draining elements positioned within the feeding section (11) and along the medial section (14). Also, referring to FIG. 4, the press cage (10) has a draining element (15) located in the medial section (14) and is configured to retain a cake comprising vegetable solids and drain vegetable oil. The twin-screw press (1) further includes a first screw (2) and a second screw (3) (not shown) that are arranged inside the press cage (10) (shown in FIG. 1 or 2).

Referring to the embodiment of FIG. 1, each screw (2, 3) includes a shaft (21) arranged inside the press cage (10), and a flighting (22) arranged on the shaft (21); a distal end (4) mounted in a bearing housing (16). Furthermore, each screw (2, 3) has a proximal end (5) configured to be connected to a motor (27), wherein the screws (2, 3) are connected to it. Optionally, distal end (4) of the screws (2, 3) is also configured to be connected to a power transmission unit (6).

The twin-screw press (1) also may include a discharge-restricting device (7) connected to the cake discharge section (13) and configured to control a cake flow.

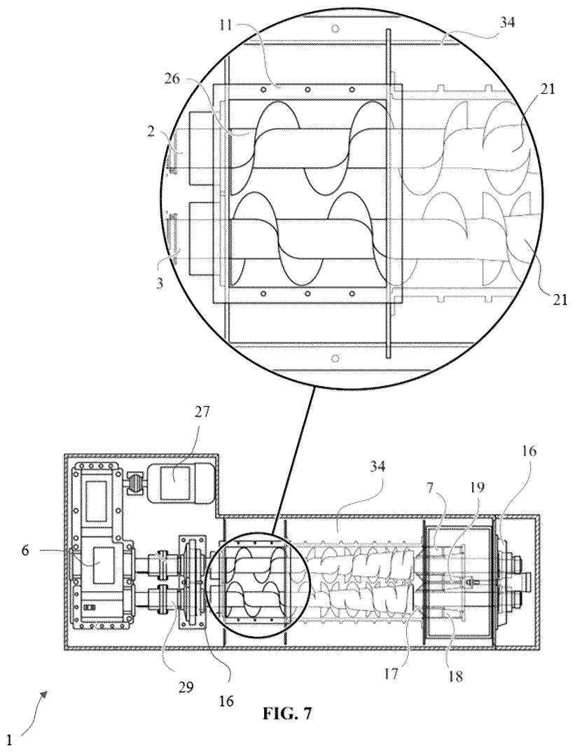

In an alternative embodiment, as shown in FIG. 7, the screws (2, 3) can be connected to a feeding portion (26) that may be a double output shaft gearbox, providing multiple variations in the mechanical configuration of the screws (2, 3). It is worth noting that in the embodiment of a single output shaft gearbox or double output shaft gearbox can optionally be connected to a motor (27).

Any of the herein-described embodiments of the twin-screw press (1), and the processes utilizing them, permit a substantial reduction in power requirements for operation, minimized breakage of oil palm nuts during processing, and significantly enhanced oil extraction rates in comparison with single screw presses.

Also, for palm oil extraction, the herein-described twin-screw press (1) reduces the rate of oil palm nuts broken in the pressing phase. This consequently eliminates the presence of lauric acid in the production of palm oils. These advantages are acknowledged by having screws (2, 3), intermeshed between them, and having, in one embodiment a transmission unit with a single output shaft gear box, or a double output shaft gearbox. Furthermore, the flighting (22) is configured to maintain a gap with the draining element (15) preventing damage to the nuts of the vegetable fruits, such as oil palm fruits. Flighting (22) is the helicoid, corkscrew, surface that wraps around the shaft (21) of a screw (2, 3), somewhat like threads on a rod.

In some embodiments of the herein-described twin screw press (1), the shaft (21) may have a constant cross-section. Also, in other embodiments, the shaft (21) may have a conical shape. Preferably, the shaft (21) with conical shape has a larger cross-section near the cake discharge section (13) of the press cage (10).

Also, the twin-screw press (1) allows for a significant reduction or even elimination of the use of fluid addition which fluid must subsequently be removed from the oil being produced, and a reduction of oil content in the press cake fiber (i.e., oil loss). Furthermore, the herein-described embodiments of the twin-screw press (1), and the corresponding single output shaft gearbox or double output shaft gearbox, provide an advantage in the case of palm oil extraction process, as the screws (2, 3) with shafts (21), and provided in an intermeshed arrangement, allows the removal of fibers from oil palm fruit nuts through friction, preventing nut breakage, and preserving the quality of the Palm Kernel Oil (PKO).

Furthermore, the twin-screw press (1) provides a reduction in machine cost and maintenance due to its low operating torque requirements and allows an improved operation with the oil extraction with less oil loss. This is a consequence of allowing lower processing temperatures and pressures due to the screws (2, 3) geometry and the gap with the draining element (15) of the press cage (10). This also permits reducing the possibility of material jamming or co-rotating with the screws.

Referring to FIG. 1, FIG. 3 and FIG. 7, the press cage (10) includes a feeding section (11), a cake discharge section (13) and a medial section (14) located between the feeding section (11) and the cake discharge section (13). In the feeding section (11) a mass flow of vegetable fruits and/or seeds to be processed in the twin-screw press (1) is received. The feeding section (11) may comprise a hopper that includes an oil draining screen in the bottom (not illustrated) and provides an pre-drained mass flow of vegetable fruits and/or seeds. The press cage (10) may further include a housing (34) connected to the structure (37) or frame of the twin-screw press (1) and arranged around the draining element (15). The housing (34) keeps the extracted oil and liquids inside the press cage (10). The housing (34) may further include a liquid collection section (35) configured to receive oil and or liquids extracted from the vegetable fruits and/or seeds. The liquid collection section (35) is connected to a lower edge of the housing (34). Also, the liquid collection section (35) may comprise a liquid discharge outlet configured to be connected to a fluid pipe. The liquid discharge outlet preferably includes a pipe fitting (36) configured to connect the liquid collection section (35) to a fluid pipe.

Referring to FIG. 2, as for the first screw (2) and second screw (3), each screw (2, 3) has a feeding portion (26), located in the feeding section (11) of the press cage (10). The feeding portion (26) of each screw (2, 3) may have a constant pitch in the flighting (22) and may also have a constant diameter of the shaft (21). In this embodiment, the conical shape of the shaft (21) may extend from a medial portion towards a distal portion of the screws (2, 3). This permits an even distribution of the vegetable fruits and/or seeds and applying gradually the pressure needed to crush the pulp, from the cake, and squeeze the oil and/or liquids, without overheating the vegetable fruits and/or seeds. Also, in the case of oil palm fruits, this prevents that the nuts crack.

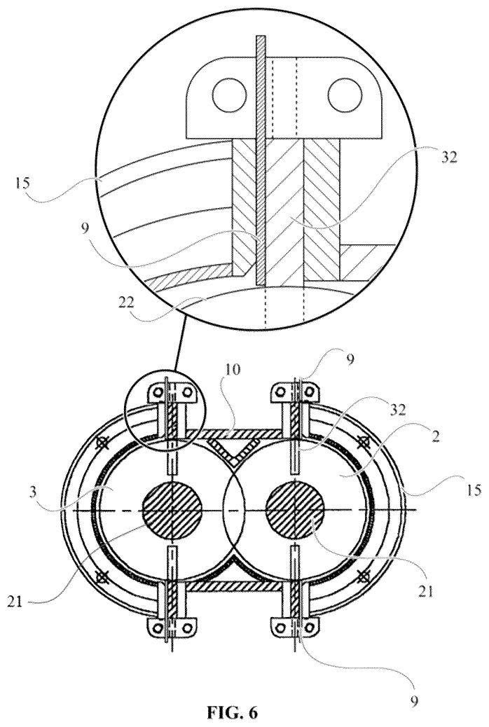

Referring to FIG. 4 and FIG. 6, the draining element (15) of the press cage (10) is configured to retain the insoluble solids and cake and drain the vegetable oil. To facilitate this function, the press cage (10) may comprise additional strainers and draining elements positioned alongside the main draining element (15). The draining element (15) may have a tubular shape extending parallel to the screws (2, 3). The draining element (15) may include a wedgewire or perforated sheets that configure a filtering screen. In different embodiments, the draining element (15) includes a slotted screen made from a wedgewire sheet, a perforated screen, a wire mesh, or a combination thereof. Furthermore, the draining element (15) may include mesh layers that form an additional filtering screen mounted underneath and between the screws (2, 3).

Referring to FIG. 1, the screws (2, 3) have a distal end (4) mounted in a bearing housing (16) and a proximal end (5) connected to a power transmission unit (6). The power transmission unit (6) may be a gearbox of a single output shaft gearbox, or the gearbox may be a double output shaft, or it might even comprise gearboxes with multiple shafts to suit a range of mechanical configurations and power distribution requirements.

The aforementioned gearbox or gearboxes are operatively coupled to one or more motors (27). This connection facilitates the conversion of electrical energy into mechanical motion, driving the gearbox(es) and, subsequently, transmitting power to the shafts (21) of the screws (2, 3) through a coupling element (29).

It should be noted that a coupling element (29) may be selected based on the operational requirements and mechanical characteristics desired, such as the need for torque transmission, alignment accuracy, angular or axial flexibility, maintenance requirements, etc. The coupling element (29) include, but is not limited to, rigid couplings, split sleeve couplings, flange or plate couplings, movable couplings, splined sleeves, flexible joints, universal joints, homokinetic joints or equivalent couplings known to a skilled artisan.

The power transmission unit (6) may include gears, pulleys, belts, geared belts, chains, sprockets, shafts, transmission shafts, spindles, similar, and equivalent transmission elements known by a skilled artisan, and combinations thereof. In some embodiments of the apparatus, the motor (27), and the power transmission unit (6) form a geared motor reducer.

The power transmission unit (6) may be selected between worm gear reducers, gear reducers, cycloidal reducers, planetary reducers, similar, and equivalent transmission devices known by a skilled artisan, and combinations thereof.

The motor (27) may be an electric motor selected from alternating current motors (e.g. three-phase synchronous motors, synchronized asynchronous motors, motors with a permanent magnet rotor, single-phase motors, two-phase motors, wound starter motors, wound starter, and capacitor starter motors), direct current motors (e.g. series excitation motors, parallel excitation motors, compound excitation motors), stepper motors (e.g. with encoder, with motor brake, with heat sinks, with inertial heat sinks, with gear reducers one, two or three-stage planetariums), NEMA 8, NEMA 11, NEMA 17, NEMA 23 or NEMA 34 class stepper motors, equivalent electric motors known to a skilled artisan, and combinations thereof.

Alternatively, the electrical motor can be replaced by a hydraulic motor, internal combustion engine or a steam turbine.

Preferably, the distal bearing housing (16) includes thrust bearings. Also, the proximal end (5) may be also mounted on a bearing housing (16) including roller bearings. These bearings permit an easier assembly and maintenance of the twin-screw press (1). Preferably, the bearing housings (16) are connected to a structure (37) or frame of the twin-screw press (1). Also, when the discharge-restricting device (7) includes linear actuators (20), said linear actuators (20) permit having a better and safer coupling and better operating conditions of the roller and thrust bearings. Furthermore, roller and thrust bearings provide a better alignment and less vibration in comparison to other types of bearings, which permits connecting the screws (2, 3) to the power transmission unit (6) with rigid couplings.

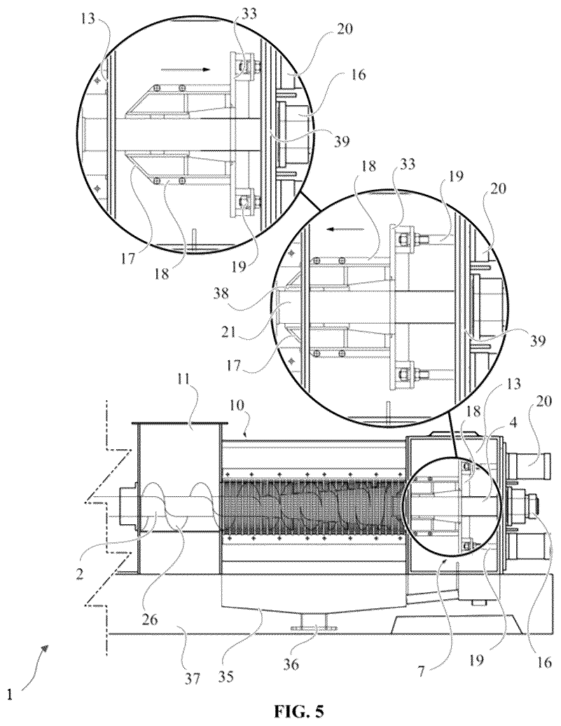

Referring to FIG. 5, the twin-screw press (1) includes a discharge-restricting device (7) connected to the cake discharge section (13) and configured to control a cake flow. The discharge-restricting device (7) may include a pair of conical plungers (18), each conical plunger (18) having a conical face (17) to accommodate the shafts (21). Each conical plunger (18) may have a central hollow section (38) configured to receive the conical shafts (21). In this case, the cake discharge section (13) may include an axial outlet having semicircular sections configured to form a gap with the screws (2, 3). Furthermore, said gap of the axial outlet is configured to allow that the conical face (17) of each conical plunger (18) penetrates the press cage (10). The pressure applied by the conical plungers (18) to the cake depends on the clearance formed between the conical face (17) and the axial outlet of the cake discharge section (13). The discharge-restricting device (7) permits developing a pressure inside the press cage (10) required to squeeze the oil from the cake and reduce the oil loss that would be retained in the cake in the case that said cake is not submitted to enough pressure.

In any of the herein-described embodiments of the twin-screw press (1), the discharge-restricting device (7) may further include at least a linear actuator (20) having at least a rod (19), the pair of conical plungers (18) connected to the at least one rod (19), and having the conical face (17) configured to be inserted into an outlet of the cake discharge section (13), wherein the conical plunger (18) applies a resistance force to the cake that exits through the outlet of the cake discharge section (13).

In these embodiments, the linear actuator (20) permits regulating the clearance formed between the conical faces (17) of the conical plungers (18) and the axial outlet of the cake discharge section (13).

Furthermore, referring to FIG. 5, the discharge-restricting device (7) may include a plurality of linear actuators (20) connected to a moving plate (33). The moving plate (33) is parallel to a rear portion of the conical plungers (18) and orthogonal to the symmetry axes of the screws (2, 3). The moving plate (33) and the rods (19) of the linear actuators (20) may be connected by brackets with oval holes. Said brackets with oval holes provide a tolerance configured to avoid jamming of the linear actuators (20), and the conical plungers (18).

Also, a fixed plate (39) can be configured to receive the bearing housings (16) where the screws (2, 3) are mounted. Preferably, the fixed plate (39) is removably connected to a structure (37) of the twin-screw press (1). This makes assembly and maintenance activities (e.g., maintenance of the conical plungers (18), cleaning, lubrication) easier in comparison to the case when the fixed plate (39) is rigidly fixed to the structure (37) (e.g., by replaceable fixed orifices or threaded shafts for setting fixed cake discharge) of the twin-screw press (1).

Referring to FIG. 1 and FIG. 3, in some embodiments of the twin-screw press (1), conical shafts (21) of each screw (2, 3) allow for a gradual increase in the shaft (21) diameter towards the cake discharge section (13). This shape allows applying gradual pressure to the cake that ensures proper extraction of the oil and/or liquids extracted from the vegetable fruits and/or seeds and prevents oil loss generated when the cake leaves the press cage (10) with retained oil. Furthermore, each screw (2, 3) may have a pitch (23) that decreases towards the discharge section (13) of the press cage (10). The decreasing pitch (23) of the flighting (22) of the screws (2, 3) permits increasing the pressure applied to the cake in the cake discharge section (13) and having even better oil extraction rates.

The flighting (22) of the screws will be different, with left-hand flighting on one screw and right-hand flighting on the other. These may be arranged in a counterrotating and intermeshing layout.

Furthermore, each screw (2, 3) may have in the distal portion closer to the cake discharge section (13), a flighting (22) with a left-hand flighting section (30) and right-hand flighting section (31). Said left-hand flighting section (30) and right-hand flighting section (31) of the flighting (22) permit increasing the residence time of the vegetable fruits and/or seeds, and the cake formed by them inside the press cage (10). Also, in case the vegetable fruits and/or seeds include nuts, like the oil palm fruits, the left-hand flighting section (30) and right-hand flighting section (31) apply mechanical stresses that permit removing the pulp from the nuts without breaking the nut. Furthermore, this geometry of the flighting (22) reduces, or even eliminates the need of using solvents and liquids, like water press liquor, or oil, to soften the cake and ensure the oil extraction, as would be needed in single screw presses, or twin-screw presses having continuous flighting (22). Also, the combination of the left-hand flighting section (30) with the right-hand flighting section (31) prevents that the cake co-rotates with the screws (2, 3).

A weakness of the single screw press is that lacking positive displacement, excessive slippage can occur in the press. Thus difficult (slimy) materials, like vegetable fruits and the cake formed by them, can tend to co-rotate with the screw, resulting in a loss of both throughput and dewatering capacity. The amount of compression that can be applied to a material is limited by its tendency to slip, even in interrupted screw machines.

The outer diameters of the screws overlap in the medial section (14) in an intermeshing arrangement which creates a degree of positive displacement. The amount of overlap is varied in the constructions of the press. The amount of overlap is critical because it affects the slippage and throughput (consequently, the oil yield) of the press.

Furthermore, having screws (2, 3) with a left-hand flighting section (30), and a right-hand flighting section (31), wherein the screws (2, 3) are coupled in a counterrotating and intermeshing arrangement, prevent increasing the consistency of the cake to a point that may jam the twin-screw press (1). This would be a problem as it can apply excessive load to the screws (2, 3) and increase the power and torque needed to operate. Screws (2, 3) and power transmission unit (6) failures can result when this occurs. Accordingly, having twin overlapping screws (2, 3) achieves a degree of positive displacement, resulting in tight squeezing and a great reduction in slippage. This improves dewatering of slimy materials, like cake of vegetable fruits and/or seeds. On the other end of the scale, there is enough give to the interrupted configuration that jamming is minimized.

Referring to FIG. 1, and FIG. 3, in some of the embodiments of the twin-screw press (1), the flighting (22) of each screw (2, 3) may be discontinuous and form gaps (24) between flighting sections (25). Also, the press cage (10) may further include a resistor element (8) including a plurality of resistor teeth (32) configured to fit the gaps (24) of the flighting (22) of each screw (2, 3). The gaps (24) and resistor teeth (32) stir the material being pressed, which has the effect of both reducing co-rotation and placing fresh, wet material against the draining element (15) of the press cage (10), hence dewatering is achieved with the low L/D ratios typical of interrupted screw presses. L/D is defined as length of screen divided by diameter of screw.

Referring to FIG. 3, the stationary resistor teeth (32) are fixed to a frame of the twin-screw press (1), so that they protrude through the draining element (15) at the locations where the flighting (22) of the screws (2, 3) is interrupted. The resistor teeth (32) are in the flow of material passing through the twin-screw press (1). Also, the resistor teeth (32) can range in length from very short to reaching almost to the shaft (21) of the screws (2, 3). The screws (2, 3) cause stirring which both reduces co-rotation (slippage) tendency and puts wet material against the draining element (15).

Referring to FIG. 4, and FIG. 6, in any of the embodiments of the twin-screw press (1) the press cage (10) may further include a plurality of adjustment elements (9) configured to set a clearance distance between the flighting (22) of the screws (2, 3) and the draining element (15). The adjustment elements (9) also can be replaced, if wear appears. This permits adjusting the screw-to-screen clearance (distance between the flighting (22) and the draining element (15)) for optimal oil and/liquid extraction and draining element (15) life. Preferably, the adjustment elements (9) are a plurality of longitudinal shims placed along the draining element (15).

In any of the embodiments of the twin-screw press (1) the press cage (10) may further include a plurality of spray manifolds for spraying cleaning fluid to the outside of the draining element (15). The spray manifolds prevent clogging of the draining element (15).

Additionally, the present disclosure describes embodiments of a process for extracting vegetable oils with a twin-screw press (1) according to any of the herein-described embodiments. The process includes:
feeding vegetable fruits and/or seeds in a feeding section (11) of a press cage (10) of the twin-screw press (1);
obtaining a cake and an oil/and or liquid by processing the vegetable fruits along a medial section (14) of the press cage (10), applying a shared compression force with a first screw (2) and a second screw (3) arranged inside the press cage (10).
   The process further includes a step of:
extracting the oil and/or liquids through a draining element (15) of the press cage (10); and
extracting the cake through a cake discharge section (13) located in a distal zone of the press cage (10), wherein the cake includes nuts and pulp of the vegetable fruits and/or seeds.

According to the embodiments of the present disclosure, the operating temperature encompasses a range from ambient temperature to 100° C. This range includes, but is not limited to, between ambient temperature to 59° C.; between ambient temperature to 60° C.; between ambient temperature to 100° C.; between 60° C. to 100° C.; and any other combination that optimizes the extraction efficiency for fruit materials exhibiting different viscosities and oil content.

In the step of feeding vegetable fruits and/or seeds in a feeding section (11), the twin-screw press (1) receives preprocessed fruits and/or seeds. Examples of vegetable fruits and seeds are oil palm fruit, sunflower seeds, olive fruit, fruits of plants of the Elaeis guineensis, Elaeis guineensis x Elaeis oleifera, Elaeis genre, and any other suitable fruit or seed known by a skilled person, and combinations thereof.

For example, in the case of the oil palm fruit, before executing the feeding step of the herein-described method, fresh oil palm fruit bunches are first sterilized, for example, in an autoclave. Later, the fresh oil palm fruit bunches (FFB or Fresh Fruit Bunches) already sterilized go to a stage of debranching the fresh oil palm fruit bunches (FFB) and obtaining oil palm custard and fruit. This stage is generally done with mechanical means, for example, using any suitable machine or device configured to separate the oil palm fruits from the custard.

Optionally, the oil palm fruits are processed by an apparatus configured to apply a thermomechanical treatment, usually a digester, with heating rates and operating pressures, and agitation and beating conditions that allow macerating the oil palm fruit. In addition, this stage permits preparing the oil palm fruits for a pressing stage. For example, a digester may preprocess the oil palm fruits at a temperature between 60° C. and 100° C., and ambient temperature to 100° C. This range includes, but is not limited to, between ambient temperature to 59° C.; between ambient temperature to 60° C.; between ambient temperature to 100° C.; or between 60°° C. to 100° C. For cold pressing, it would be required a pre-heating process.

Feeding the twin-screw press (1) with vegetable fruits may comprise using hoppers configured to maintain a constant flow of vegetable fruits and/or seeds to the feeding section (11). Also, the feeding step may further include using conveyor mechanisms that control the mass flow of vegetable fruits fed to the feeding section (11) of the press cage (10).

Simultaneously, the speed (RPM) of the screws can be varied to obtain the maximum dwell time for the material in the draining element (15). Twin screw presses with overlapping flights are highly responsive to changes in screw speed, making them preferred over other presses.

The step of obtaining a cake and an oil by processing the vegetable fruits and/or seeds along a medial section (14) of the press cage (10), applying a shared compression force with a first screw (2) and a second screw (3), that arranged inside the press cage (10), permits dewatering the fruit and release oil and liquids. This step is executed simultaneously with the step of extracting the oil through a draining element (15) of the press cage (10).

The draining element (15) retains the solids and nuts (in the case of the oil palm fruit and similar fruits). Preferably, the twin-screw press (1) is provided with adjustment elements (9) that control the gap between the draining element (15), in particular, the filtering screen, sheet or wedgewire that is closer to the screws' (2, 3) flighting (22). Accordingly, the step of obtaining the cake and oil and/or liquids, and the step of extracting the oil and/or liquids, may increase the oil extraction rate by adjusting the gap between the adjustment elements (9) and the draining element (15).

In the case of processing oil palm fruits, the oil that passes through the draining element (15) is also called crude palm oil or press liquor.

The press liquor comprises a plurality of fats, oils, moisture, and soluble and traces of insoluble solids. In particular, the press liquor includes moisture, free fatty acids (FFA), chlorophyll and beta-carotenes. The quality of the press liquor will depend on the concentration of certain fatty acids, like the Caprilic or octanoic acid (C-8:0), Capric or decanoic acid (C-10:0), lauric or dodecanoic acid (C-12:0), myristic or tetradecanoic (C-14:0), palmitic or hexadecenoic acid (C-16:0), palmitoleic or hexadec-9-enoic acid (C-16:1), stearic or octadecanoic acid (C-18:0), oleic or cis-9-octadecenoic acid (C-18:1), linoleic or cis, cis-9,12-Octadecadienoic acid (C-18:2), linolenic or octadecatrienoic acid (C-18:3), and arachidic or eicosanoic (C-20:0).

The oil palm nuts include a particular crude oil, also known as palm kernel oil (PKO), which has high concentrations of lauric (C-12:0), myristic (C-14:0), and palmitic (C-16:0) fatty acids. These acid fats are saturated, hence they are not desired for food-grade oils, whereas monounsaturated acid fats are preferred. In particular, lauric acid is believed to raise blood cholesterol levels.

Accordingly, the herein-described method permits obtaining lauric acid concentrations between 0.02% and 0.07% which are significantly lower than the standard concentrations that can be obtained using conventional screw presses. Furthermore, the twin-screw press (1) permits extracting higher concentrations of palm oil from the cake without increasing the temperature above the 100° C., being preferent an operating temperature between 60° C. and 82° C. Said oil (crude oil or press liquor) extracted through the draining element (15) may include beta-carotene concentrations between 799 ppm and 1100 ppm (measured using Near Infrared-NIR-spectrometry devices). Accordingly, the method permits increasing the quality of the press liquor in comparison to other conventional oil presses.

On the other hand, the step of extracting the cake through a cake discharge section (13) located in a distal zone of the press cage (10), includes restraining the cake with the discharge-restricting device (7) of the twin-screw press (1). The discharge-restricting device (7) applies pressure to the cake, which permits pressurizing the press cage (10). For example, when the discharge-restricting device (7) includes a conical plunger (18), the conical face (17) of the conical plunger (18) penetrates an axial outlet of the cake discharge section (13) forming a gap that permits the cake to exit.

### EXAMPLES

### Example 1: Twin-Screw Press (1) for Palm Oil Extraction

A first example of the twin-screw press (1) includes a press cage (10) including a feeding section (11) with a rectangular inlet configured to receive vegetable fruits. The feeding section (11) has a length of 508 mm. The cake discharge section (13) is 548 mm long. The medial section (14) is 1175 mm long.

In the medial section (14) of the press cage (10) a resistor element (8) is provided having resistor teeth (32). The distance between the resistor teeth (32) decreases towards the cake discharge section (13). The press cage (10) further includes a housing (34) having in its lower edge a liquid collection section (35) configured to receive oil extracted from the vegetable fruits.

Each screw (2, 3) has a conical shaft (21) convergent towards the cake discharge section (13). Also, each screw (2, 3) in connected to a power transmission unit (6) by rigid coupling and is mounted on bearing housings (16) including roller and thrust bearings. The power transmission unit (6) is connected to a motor (27) that, in this example, is a motor-reducer having 29.8 kW (40 HP) of power. Furthermore, each screw (2, 3) has a flighting (22) having a decreasing pitch (23) towards the cake discharge section (13).

The twin-screw press (1) of this example includes a discharge-restricting device (7) having a pair of conical plungers (18), each conical plunger (18) having a conical face (17) that penetrates an axial outlet of the cake discharge section (13). The conical plungers (18) are connected to a moving plate (33) using brackets with oval holes and fasteners. The moving plate (33) is connected to rods (19) of a pair of linear actuators (20) that provide the force needed to restrain the cake with the conical plungers (18).

### Example 2: Method to Extract Palm Oil

The method was executed using the twin-screw press (1) of Example 1, receiving a stream of preprocessed oil palm fruits from a digestor at a mean temperature of 80° C. In this example three batches of High Oleic Palm fruits from Elaeis guineensis x Elaeis oleifera and other three batches of Elaeis guineensis Palm fruits were processed. The operation temperature was maintained at 80° C.

Table 1 shows the concentrations of free fatty acids, moisture, iodine value (IV), Deterioration of Bleachability Index (DOBI), Chlorophyll (ppm), and Beta-carotene (ppm) in the obtained press liquor.

TABLE 1

| | | | | | Chlorophyll | Beta-carotene |
|---|---|---|---|---|---|---|
| Fruit | % FFA | % Moisture | IV | DOBI | (ppm) | NIR (ppm) |
| High Oleic | 2.4 | 0.27 | 69.2 | 3.31 | 0.0000 | 1061 |
| High Oleic | 2.38 | 0.26 | 68.42 | 3.04 | 0.0000 | 1048 |
| High Oleic | 3.3 | 0.21 | 68.77 | 3.64 | 0.0000 | 1105 |
| High Oleic | 3.61 | 0.27 | 64.05 | 3.07 | 0.0000 | 957 |
| Guineensis | 1.91 | 0.32 | 64.2 | 3.59 | 0.0789 | 1095 |
| Guineensis | 3.75 | 0.37 | 65.43 | 2.65 | 0.0225 | 1236 |
| Guineensis | 1.44 | 0.21 | 64.55 | 3.87 | 0.0000 | 912 |

Tables 2 and 3 show the concentrations of fatty acids for each batch, except the last batch of Elacis guineensis oil palm fruits:

TABLE 2

| | Caprilic | Capric | Lauric | Myristic | Palmitic | Palmitoleic |
|---|---|---|---|---|---|---|
| Fruit | (C-8:0) | (C-10:0) | (C-12:0) | (C-14:0) | (C-16:0) | (C-16:1) |
| High Oleic | — | — | 0.04 | 0.51 | 33.93 | — |
| High Oleic | — | — | 0.05 | 0.65 | 36.92 | — |
| High Oleic | — | — | 0.05 | 0.42 | 30.9 | — |
| High Oleic | — | — | 0.31 | 0.85 | 41.98 | — |
| Guineensis | — | — | 0.04 | 0.74 | 40.87 | — |
| Guineensis | — | — | 0.06 | 0.9 | 43.66 | — |

TABLE 3

| | Stearic | Oleic | Linoleic | Linolenic | Arachidic |
|---|---|---|---|---|---|
| Fruit | (C-18:0) | (C-18:1) | (C-18:2) | (C-18:3) | (C-20:0) |
| High Oleic | 3.57 | 50.56 | 11.13 | 0.25 | — |
| High Oleic | 3.42 | 48.19 | 10.54 | 0.23 | — |
| High Oleic | 3.46 | 52.92 | 11.99 | 0.26 | — |
| High Oleic | 3.48 | 43.4 | 9.77 | 0.2 | — |
| Guineensis | 3.49 | 44.98 | 9.63 | 0.25 | — |
| Guineensis | 3.64 | 41.52 | 9.98 | 0.24 | — |

As for the cake oil retention, in this example, it was between 5.1% and 14.8%, and the moisture content was between 36.9% and 40.7%.

The results of this process reflect a considerable reduction in the lauric acid concentration in comparison to conventional oil presses. Also, the cake oil retention was lower.

### Example 3: Method to Extract Palm Oil

In a second example of the method, it was processed seven batches of High Oleic oil palm fruits. Table 4 shows the concentrations of free fatty acids, moisture, iodine value (IV), Deterioration of Bleachability Index (DOBI), Chlorophyll (ppm), and Beta-carotene (ppm) in the obtained press liquor. Tables 5 and 6 show the concentrations of fatty acids for each batch of Elaeis guineensis x Elaeis oleifera or high oleic oil palm fruits:

TABLE 4

| | | | | | Chlorophyll | Beta-carotene |
|---|---|---|---|---|---|---|
| Fruit | % FFA | % Moisture | IV | DOBI | (ppm) | NIR (ppm) |
| High Oleic | 2.4 | 0.27 | 69.2 | 3.31 | 0.0000 | 1061 |
| High Oleic | 2.38 | 0.26 | 68.42 | 3.04 | 0.0000 | 1048 |
| High Oleic | 3.3 | 0.21 | 68.77 | 3.64 | 0.0000 | 1105 |
| High Oleic | 3.61 | 0.27 | 64.05 | 3.07 | 0.0000 | 957 |
| High Oleic | 1.91 | 0.32 | 64.2 | 3.59 | 0.0789 | 1095 |
| High Oleic | 3.75 | 0.37 | 65.43 | 2.65 | 0.0225 | 1236 |
| High Oleic | 1.44 | 0.21 | 64.55 | 3.87 | 0.0000 | 912 |

TABLE 5

| | Caprilic | Capric | Lauric | Myristic | Palmitic | Palmitoleic |
|---|---|---|---|---|---|---|
| Fruit | (C-8:0) | (C-10:0) | (C-12:0) | (C-14:0) | (C-16:0) | (C-16:1) |
| High Oleic | — | — | 0.02 | 0.27 | 28.07 | — |
| High Oleic | — | — | 0.03 | 0.29 | 28.87 | — |
| High Oleic | — | — | 0.04 | 0.4 | 28.93 | — |
| High Oleic | — | — | 0.04 | 0.51 | 33.47 | — |
| High Oleic | — | — | 0.03 | 0.38 | 33.37 | — |
| High Oleic | — | — | 0.07 | 0.38 | 31.96 | — |
| High Oleic | — | — | 0.04 | 0.36 | 32.68 | — |

TABLE 6

| | Stearic | Oleic | Linoleic | Linolenic | Arachidic |
|---|---|---|---|---|---|
| Fruit | (C-18:0) | (C-18:1) | (C-18:2) | (C-18:3) | (C-20:0) |
| High Oleic | 3.61 | 57.02 | 10.76 | 0.25 | — |
| High Oleic | 3.65 | 56.25 | 10.66 | 0.25 | — |
| High Oleic | 3.83 | 56 | 10.56 | 0.24 | — |
| High Oleic | 3.54 | 51.18 | 11.03 | 0.23 | — |
| High Oleic | 3.6 | 51.89 | 10.51 | 0.22 | — |
| High Oleic | 3.69 | 53.16 | 10.52 | 0.22 | — |
| High Oleic | 3.39 | 53.27 | 10.04 | 0.22 | — |

### Example 4: Method to Extract Palm Oil

In a third example of the method, High Oleic palm fruits or Elaeis guineensis x Elaeis oleifera palm fruits were processed from 8:00 am to 4:00 pm using the twin-screw press (1) of Example 1 to assess the Oil Extraction Rate (OER) and to monitor process variables. Table 7 shows the performance of the twin-screw press in tons per day and the Oil Extraction Rate of 26.49%. Table 8 shows the process monitoring of the twin-screw press for four sample intervals.

TABLE 7
Performance of twin-screw press
Operations 8:00 am to 4:00 pm

| | |
|---|---|
| Extracted Oil, ton/day | 17910 |
| Number of Wagons | 32 |
| Average Wagon, ton/day | 2113 |
| Processed fruit, ton/day | 67617 |
| Working hours | 8 |
| Capacity/hours | 8452 |
| Oil extraction rate (OER), % | 26.49% |

TABLE 8
Process monitoring of twin-screw press
with High Oleic Palm Oil Fruits

| | | Nuts | | | |
|---|---|---|---|---|---|
| | | Breakage, | Digester | Press | Pressure, |
| #Analysis | Dilution | % | Temperature, ° C. | Amp | psi |
| Sample 1 | 1.17 | 0% | 60 | 35 | 110 |
| Sample 2 | 1.17 | 10% | 80 | 27 | 110 |
| Sample 3 | 1.03 | 0% | 90 | 23 | 110 |
| Sample 4 | 1.18 | 5% | 80 | 26 | 110 |
| Average | 1.14 | 4% | 77.5 | 27.75 | 110 |

### Example 5: Method to Extract Cold Pressed Palm Oil

In this example of the method, it was processed three batches of High Oleic oil palm fruits of different interspecific hybrids of Elaeis guineensis x Elaeis oleifera, Coari x Lame fortuna, Amazon and Manicore.

Table 9 shows the OER (Oil Extraction Rate), oil content in the press cake fiber, the concentrations of free fatty acids (FFA), moisture, iodine value (IV), Beta-carotene (ppm), Mosh (Mineral Oil Saturated Hydrocarbons), Moah (Mineral Oil Aromatic Hydrocarbons) and total tocols (tocopherols and tocotrienols in ppm) in the obtained press liquor.

TABLE 9

| | | | | | % Oil in |
|---|---|---|---|---|---|
| | | | % | | Press Cake |
| Fruit | Type | % Oil | Sludge | TEA/OER | Fiber |
| Hybrid | Coari x Lame | 60 | 40 | 28.12% | 12.29 |
| | fortuna | | | | |
| Hybrid | Amazon | 69 | 31 | 33.18% | 12.08 |
| Hybrid | Manicore | 72 | 28 | 32.32% | 8.42 |

| FFA | Moisture | Beta- Carotene | MOSH | MOAH | Total Tocols |
|---|---|---|---|---|---|
| (%) | (%) | (ppm) | (ppm) | (ppm) | (ppm) |
| 2.42 | 0.22 | 1982 | 5.97 | <1 | 739.14 |
| 1.29 | 0.19 | 1717 | 4.27 | <1 | 668.96 |
| 0.79 | 0.16 | 1817 | 7.85 | <1 | 856.27 |

Table 10 shows the concentrations of fatty acids for each batch of different interspecific hybrids of Elaeis guineensis x Elaeis oleifera in the obtained press liquor.

| | | | Lauric | Miristic |
|---|---|---|---|---|
| Date | Fruit | Type | (C-12:0) | (C-14:0) |
| Jan. 2, 2024 | Hybrid | Coari x Lame | 0.04 | 0.22 |
| | | fortuna | | |
| Feb. 2, 2024 | Hybrid | Amazon | 0.02 | 0.34 |
| Feb. 2, 2024 | Hybrid | Manicore | 0.03 | 0.25 |

| Palmitic | Stearic | Oleic | Linoleic | Linolenic |
|---|---|---|---|---|
| (C-16:0) | (C-18:0) | (C-18:1) | (C-18:2) | (C-18:3) |
| 27.92 | 1.74 | 56.53 | 13.17 | 0.38 |
| 35.43 | 3.01 | 50.35 | 10.52 | 0.33 |
| 27.59 | 2.72 | 53.09 | 15.82 | 0.50 |

What is claimed is:

1. A twin-screw press for extracting vegetable oils, comprising:
a press cage, including;
a feeding section located in a proximal zone of the press cage;
a cake discharge section located in a distal zone of the press cage;
a medial section located between the feeding section and the cake discharge section;
a draining element located in the medial section and configured to retain a cake comprising vegetable solids and drain vegetable oil;
a first screw and a second screw, and arranged inside the press cage, each screw, including:
a shaft arranged inside the press cage;
a flighting arranged on the shaft;
a distal end mounted in a bearing housing;
a proximal end mounted in a bearing housing;
wherein at least one end of each screw is configured to be connected to a power transmission unit;
wherein the screws are intermeshed between them overlapping; and
a discharge-restricting device connected to the cake discharge section and configured to control a cake flow.

2. The twin-screw press of claim 1, wherein the power transmission unit is connected to a gearbox that may be a single, double or multiple output shaft gearbox.

3. The twin-screw press of claim 2, wherein a coupling element connects the gearbox to the shaft of the screws.

4. The twin-screw press of claim 1, wherein the shaft of each screw is conical and convergent towards the discharge section of the press cage.

5. The twin-screw press of claim 1, wherein the flighting of the first screw has a left-hand orientation and the flighting of the second screw has a right-hand orientation, and wherein the screws are coupled in a counterrotating and intermeshing arrangement.

6. The twin-screw press of claim 1, wherein each screw has a pitch that decreases towards the discharge section of the press cage.

7. The twin-screw press of claim 1, wherein the flighting of each screw is discontinuous and forms gaps between flighting sections, and
wherein the press cage further includes a resistor element including a plurality of resistor teeth configured to fit the gaps of the flighting of each screw.

8. The twin-screw press of claim 1, wherein the press cage further includes a plurality of adjustment elements configured to set a clearance distance between the flighting of the screws and the draining element, and wherein, preferably, the adjustment elements are longitudinal shims placed along the draining element.

9. The twin-screw press of claim 1, wherein the distal end and the proximal end of each screw are mounted on bearing housings, each distal bearing housing including thrust bearings.

10. The twin-screw press of claim 1, wherein the draining element includes a slotted screen made from a wedgewire sheet, a perforated screen, a wire mesh, or a combination thereof.

11. The twin-screw press of claim 1, wherein the discharge-restricting device includes:
at least a linear actuator having two rods;
a pair of conical plungers, each conical plunger connected to a rod, and having a conical face configured to be inserted into an outlet of the cake discharge section;
wherein the conical plunger applies a resistance force to the cake that exits through the outlet of the cake discharge section.

12. The twin-screw press of claim 1, wherein the press cage further includes a plurality of spray manifolds for spraying cleaning fluid to the outside of the draining element.

13. The twin-screw press of claim 1, wherein the bearing housings are fixed to a frame of the twin-screw press.

14. A process for extracting vegetable oils with a twin-screw press according to claim 1, comprising:
feeding vegetable fruits and/or seeds in a feeding section of a press cage of the twin-screw press;
obtaining a cake and an oil by processing the vegetable fruits and/or seeds along a medial section of the press cage, applying a shared compression force with a first screw and a second screw that are arranged inside the press cage;
extracting the oil through a draining element of the press cage;
extracting the cake through a cake discharge section located in a distal zone of the press cage, wherein the cake includes nuts and pulp of the vegetable fruits and/or seeds;
wherein the operating temperature is between ambient temperature to 100° C.

15. The process of claim 14, where tithe operating temperature is between ambient temperature to 59°° C.; between ambient temperature to 60° C.; between ambient temperature to 100°° C.; and between 60°° C. to 100°° C.
